(19) United States
(12) Patent Application Publication
(10) Pub. No.: US 2006/0020402 A1
(43) Pub. Date: Jan. 26, 2006

(54) Method and surveillance system for surveilling the state of work machines

(76) Inventors: Lutz Bischoff, Dellfeld (DE); Folker Beck, Massweiler (DE); Klaus Braunhardt, Zweibrucken (DE); Thomas Herlitzius, Dellfeld (DE)

Correspondence Address: Dawn C. Wolff;Patent Department, DEERE & COMPANY, One John Deere Place, Moline, IL, 61265-8098, US

(21) Appl. No.: 11/198,585

(22) Filed: Aug. 5, 2005

(30) Foreign Application Priority Data
Feb. 12, 2004 (DE) 10 2004 006 848.8

(51) Int. Cl. G01B 3/44

(52) U.S. Cl. 702/34

(57) ABSTRACT

A method and a surveillance system for surveilling the state of work machines including the steps of the making available sensors for detecting the operating state of the work machines; the making available of a first work machine specific databank with construction data; the making available of a second work machine specific databank with evaluation specific reference data; and analyzing of the measured values of the sensors regarding possible faults of a work machine using the first and the second databank. If the analysis of the measured values indicates a fault in the work machine, then a presentation of information to an operator is accomplished regarding the presence of a possible fault and the determined fault location. Inputs of the operator are received regarding faults that are found by him. The measured values and/or of analyzed results derived from them and of operator inputs are transmitted to a central damage databank and the central damage databank is updated. The second databank is updated based on the updated damage databank.

### FIELD OF THE INVENTION

The invention relates to a method and a surveillance system for surveilling the state of work machines.

### BACKGROUND OF THE INVENTION

German Patent DE 101 00 522 A describes a surveillance device for a work machine. It includes one or more sensors that detect noises made by moving elements of the work machine. The signals of the sensors are compared with reference values in order to find out whether the work machine is working properly or whether there is a fault requiring a repair. The reference values stem from free work machines and are received in an investigated work machine or in corresponding work machines with a known fault.

German Patent DE 199 38 722 A describes a method of analyzing roller bearings in machines. A sensor receives a signal produced by the rolling off movement of roller bearings. The amplitude of the signal is evaluated in order to determine the presence and, optionally, the depth of damage in a roller bearing running surface. The analysis is based on a dynamic model of the roller bearings in the machine. A databank is used that contains data regarding certain properties of the bearings. Upon detecting a machine on site that is not yet entered into the databank, the properties of the bearings are detected, partially by measurements. In addition, the noises of the bearings are detected. After a successful measuring, that is, if damage is present, all machine and bearing data flow back into the central databank. In this manner the databank is continuously improved.

German Patent DE 102 28 389 A describes an oscillation sensor for surveilling the state of rotating structural parts or bearings whose output signals are digitized and analyzed by an algorithm. The actual measured values are continuously compared with defined and pre set damage patterns, which should make possible a self learning recognition of damage patterns.

An analysis of damage patterns is also disclosed in German Patent DE 102 20 124 A. Here, the measured data are first assigned to a class by comparison of the measured data with stored patterns and processed by a neuronal network. Various damage classes are stored in this network. If new damage cannot be unambiguously associated with the classes present, a new class is opened.

German Patent DE 101 45 571 A describes a system for the surveillance of construction machines. Known methods are referred to, according to which data, about the operating state of a defective construction machine including measured fault data and a fault code based on a visual examination, are sent in a wireless manner to the management department of a manufacturer where the data are examined and a repair scheduled if necessary. The criteria for damage is exactly specified.

Thus, several systems for the automatic analysis of damage to machines are known that are based on an analysis of recorded vibrations and other operating data of the machine. One problem in the automatic analysis of damage is the association between the measured values of the sensors and possible faults.

In the case of roller bearings, manageable mathematical models can be set up that permit a relatively simple association of the measured data with the state of the bearing (see German Patents DE 199 38 722 A and DE 102 28 389 A). In the case of more complicated machines, such as piston compressors and pumps, according to German Patent DE 102 20 124 A the use of teachable neuronal networks is available that are programmed in an expensive manner. It is necessary in this case to recognize the connection between the measured characteristic quantities and the actual degree of damage, which is possible for the machines cited in DE 102 20 124 A. In the case of work machines such a connection can be evaluated only in a very limited manner, since they have short development times, are quite complex and are subject to relatively high assembly tolerances. The expense that would be necessary for an experimental determinations of the necessary information is unacceptable.

The basic problem in the art is that providing a method and a surveillance system for surveilling the state of work machines that can be used in relatively complicated work machines, in which the oscillating behavior and other operating relationships such as temperature changes (e.g., in bearings, clutches) relative to structural part faults, cannot be described by simple theoretical models, nor simply analyzed.

### SUMMARY OF THE INVENTION

One embodiment of the present invention provides a method and a surveillance system for surveilling the state of a plurality of work machines. The work machines are provided with sensors that detect their operating state and/or noises or vibrations produced by movable elements of the work machine. A first databank that contains the construction data of the machine, that is, information about the particular physical construction of the machine, is provided for each individual work machine. In addition, a second databank is present that contains reference data. This databank can contain, for example, information about noises and/or vibrations and/or other typical courses of measured values in instances of damage. There is a possibility of taking into account various measured quantities such as temperature, rotation speed, performance, etc. The combination of different measured quantities is possibly a better indication of a fault than a single measured quantity or can be useful for a better localizing of a fault. An example would be a higher noise level with a simultaneous drop of rotation speed, or noise with a simultaneous change of temperature and/or of pressure. The latter is useful for the diagnosing of hydraulic systems. The sensor signals are analyzed using the first databank and the second databank. It can be recognized using the first databank which signal courses come into question as fault indicators with the given configuration of the machine. The measured signal courses are compared only with possible fault signal courses, that is, only the reference data selected from the second databank using the first databank are used for a comparison. It can be recognized, by using the second databank, whether a signal course is to be considered as critical or not. If necessary, an operator of the work machine or a responsible person is informed of the presence of a possible fault and the determined location of the fault. The responsible person can be called to the site by way of a wireless or wire connected connection, especially a telephone connection, email or the like in order to evaluate the fault. This procedure is especially advantageous if the work machine is operating without operators present. The operator can now inspect the location of the fault and optionally eliminate the damage or call a repair service. If the operator actually establishes the diagnosed fault he can make an appropriate input. Otherwise, he can input that no fault was found or that a fault was found at another location. The measured values prior to the occurrence of the fault diagnosis and/or the analysis results derived from it are transmitted to a central damage databank maintained and operated, by the manufacturer of the work machines. Successive new measured values that led to faults, and the information of the operator with respect to the faults, are entered here. The central damage databank is thus gradually updated. It also serves to update the second damage databank for the machine.

In this manner a central damage databank is gradually built up that is based on actual instances of damage. The second databank, used for the analysis of the measured values, is updated based on these instances of damage. It therefore becomes more and more reliable. The constant updating of the second databank expands the diagnosis to more and more construction elements and refines the localizing of the faults more and more. This constantly improves the quality and the automatization effect of the surveillance system. The great number of work machines being used and the different instances of use and of stress that occur make it possible for a comprehensive, statistically reliable collection of experiences to be rapidly compiled. This collection can be used to rapidly obtain an intelligent surveillance system.

The sensors also permit a monitoring of whether a repair that was made was successful. There is therefore the possibility that after a repair has been made of re subjecting the measured values of the sensors to an analysis of faults of the machine.

After a repair has been made, it is suggested that the first databank be updated in order that new parts or their new state can be taken into consideration in subsequent evaluations. In an analogous manner, the first databank is modified if the work machine is modified by the insertion or removal of parts.

The invention is particularly suitable for surveilling agricultural work machines, in particular harvesting machines.

### BRIEF DESCRIPTION OF THE DRAWINGS

An exemplary embodiment of the invention described in detail in the following is shown in the drawings.

FIG. 1 is a schematic side view of an embodiment of an agricultural axial combine cited as an example for a work machine to which the method of the present invention may be applied; and

FIG. 2 is a flow chart of the surveillance system of the combine of FIG. 1.

### DESCRIPTION OF THE PREFERRED EMBODIMENT

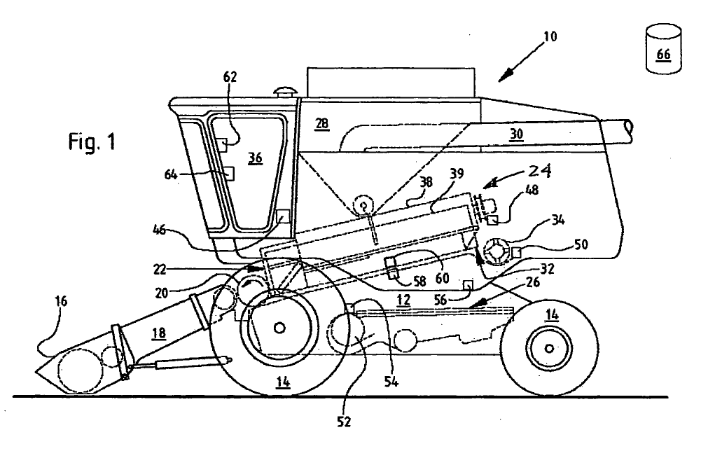

Referring now to the drawings, and more particularly to FIG. 1, there is shown an agricultural combine 10 with a frame 12 and ground wheels 14 extending down from frame 12. The invention will be explained using combine 10 as an example. Crop harvesting device 16, in the form of a cutting unit, is used to gather a crop and feed it to oblique conveyor 18. The crop is fed by oblique conveyor 18 to guide drum 20. Guide drum 20 conducts the crop upward through inlet transition area 22 to axial separating device 24.

Axial separating device 24 threshes and separates the harvested crop. Grain and chaff fall through grates on the bottom of axial separating device 24 into cleaning system 26. Cleaning system 26 removes the chaff and feeds the clean grain to a grain elevator (not shown). The grain elevator deposits the clean grain in grain tank 28. The clean grain in grain tank 28 can be unloaded by unloading worm 30 into a trailer or truck. Threshed straw freed of grain is conducted out of axial separating device 24 through outlet 32 to discharge drum 34. Axial separating device 24 comprises cylindrical rotor housing 38 and rotor 39 arranged in rotor housing 38. Discharge drum 34 ejects the straw at the rear end of combine 10.

Combine 10 is operated from driver cabin 36. Driver cabin 36 includes computer 46 connected to various sensors.

Sensor 48 is attached to axial separating device 24 and detects oscillations of rotor housing 38. Sensor 50 is fastened in the vicinity of discharge drum 34 to frame 12 and detects oscillations, caused by discharge drum 34, of the parts of frame 12 that carry it. Sensor 54 is arranged in the vicinity of a blower or ventilator 52 of cleaning device 26 on frame 12. Rotation speed sensor 58 detects the rotation speed of rotor 39 inductively using permanent magnet 60 attached to rotor 39. Sensor 56 is attached above cleaning system 26 to frame 12. Sensors 48, 50, 54 and 56 are known sensors designed to generate signals containing information about the sound waves received by sensors 48, 50, 54 and 56. They can be, in particular, acoustic or acceleration sensors.

As a result of its position, sensor 48 primarily makes information available about the movement of rotor housing 38 and therewith oscillations caused by rotating rotor 39. In an analogous manner, sensor 50 primarily makes information available about oscillations of frame 12 caused by discharge drum 34. Sensor 54 primarily makes information available about the oscillations caused by ventilator 52. Sensor 56 makes information available about the oscillations of frame 12 that are caused by all movable elements of combine 10.

Sensors 48, 50, 54, 56 and 58 are connected electrically, or optically, preferably by way of a bus line, to computer 46. Computer 46 digitizes the analog signals of the sensors, evaluates them and gives the operator in driver cabin 36 a fault message on display device 62 when a fault in combine 10 is recognized from the signals.

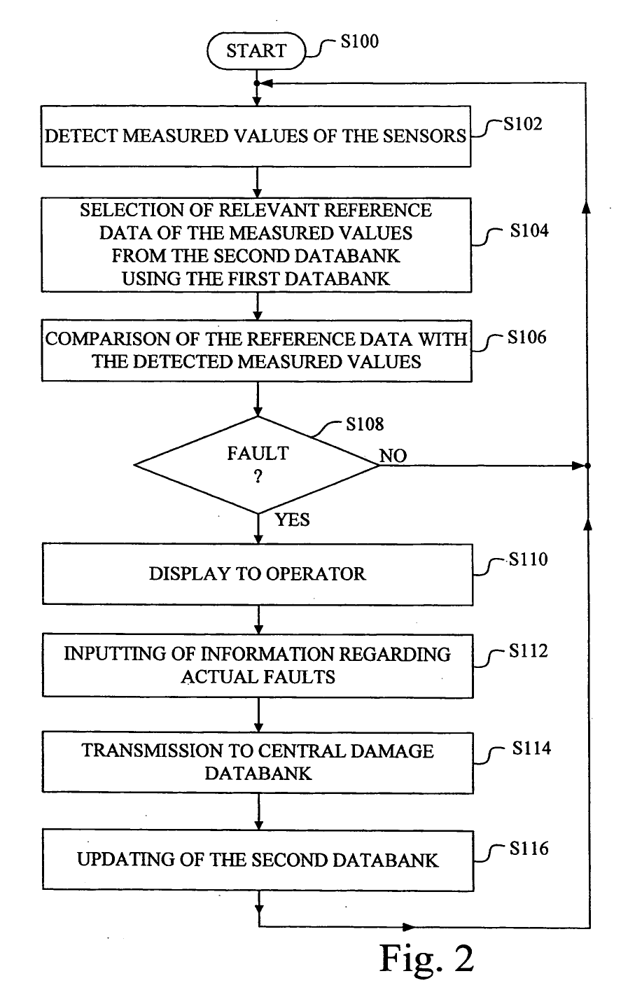

Now additionally referring to FIG. 2 there is shown a flow chart according to which the surveillance system of combine 10 functions. After the start in step 100, the measured values of sensors 48, 50, 54, 56 and 58 are detected in step 102 in computer 46. A first databank is queried in step 104, preferably after measured values over a certain time were recorded, so that a spectral analysis (Fourier transformation or the like) is possible. All relevant physical properties of the combine are entered in this databank, especially information about its moveable elements. Thus, the fact that it includes an axial separating device 24, and therefore no straw shaker, its structural part number is entered in the first databank. Furthermore, the presence of discharge drum 34 and the absence of a straw chopper are entered. The first databank is filed in a memory of computer 46.

The data in the first databank is machine specific relative to the construction and is changed only if the machine is rebuilt or retrofitted. In this instance the data can simply be adapted. The data could, for example, be read out from a machine specific file at the initiation of the surveillance system. Various possible machine configurations can be considered in this instance, and in the case of a retrofitting of combine 10, a corresponding change is made to the configuration data. In the instance of a constructive equipping or modernization of combine 10, a correspondingly new file must be established or the file must be changed, for example, by the workplace personnel involved with the rebuilding.

Computer 46 has information, based on the first databank, about how combine 10 is configured. Using this information, reference data relevant to the specific configuration of combine 10 are read out in step 104 from a second databank that is also filed in a memory of computer 46. Such reference data can include measured values saved in a time and/or frequency dependent manner that were recorded for a discharge drum 34 with defective supports, and/or theoretical and threshold values of the sensor signals and/or reference patterns for the combination of certain sensor signals. For example, temperature courses can also be saved that occur in the case of defective mountings of axial separating device 24. Only reference data that apply to the actual configuration of the machine are used. Thus, the reference data of axial separating device 24 is selected using its construction part number in order to be able to use correct reference data. In addition, the trend of the results of the previous analysis, associated with certain structural groups, can be saved in the second databank. The first and the second databank can also be integrated with one another; however, it is more logical in many instances to separate them.

It is possible, with the selected structure of the databanks, to design the entire hardware and software independently of the machine type and machine model. Machine specific data can simply be loaded via software.

The machine state is surveilled based on certain signal levels, signal patterns and/or typical combinations of signals of different sensors. The measured signals or signal patterns are associated with a certain structural part and a certain damage to the structural part. More detailed information about this association can be gathered from DE 101 00 522 A and the other publications cited in the related art portion of the specification, whose disclosure is admitted into the present documents by way of reference. Thus, using the reference data and the detected measured values, that are compared with each other in step 106, a query of whether a fault was determined using this comparison takes place in step 108 by computer 46. If this is not the case, step 102 follows again. It can also be recognized in step 108 that a fault is slowly developing. Using the results of signal analysis, conclusions can also be made, to a certain extent, about the type of damage, such as imbalances, striking of parts and/or loose connections.

If, a developing or already present fault of combine 10 is determined, step 110 follows, in which the operator is informed by way of display device 62 that a fault is present. Where the fault is located is also displayed. The operator can then go to the indicated fault location and check the fault. In addition, suggestions are given to the operator for a goal oriented diagnosis of faults by the operator as well as suggestions for repair. For this dialogue operation, information from the repair manual and from the catalog of replacement parts is made electronically available to the operator or to a called in service technician. It is possible to proceed in an interactive and/or iterative manner, that is, suggestions or questions are displayed and the operator inputs whether a certain factual situation exists or not. In this manner the operator can zero in on the fault with the support of computer 46. If a fault is actually present the operator can eliminate it to the extent possible or can call a repair service. If the operator decides that damage is present but still acceptable at the moment, he can make a corresponding input and provide the fault with a weighting (e.g., slight, average, severe). In this instance the surveillance system will observe the symptom for this fault in a concentrated manner and report when the trend moves into a critical range.

The operator or the repair service will confirm, after the repair has been finished, that a fault was actually present by a corresponding input made at step 112 into input device 64 that is connected to computer 46 and includes a keyboard. An evaluation of the fault can also be made, using criteria descriptions of slight, significant, critical, failure or the like. In this manner the automatic weighting of the fault can be improved by the surveillance system.

If the determined fault is not established or if a fault is present at another location, the operator makes an appropriate input into input device 64. Analogously, an input can also be made if computer 46 did not detect any fault in step 108 but the operator detected it himself or significant damage occurred that was detectable elsewhere and, in particular, resulted in a standstill of combine 10. As a rule, information about the type and the location of the fault is input. There is the possibility for computer 46 to scan the second databank again in order to determine whether a previously not registered change in the signals or signal patterns can be recognized here and whether these possible changes can also be logically associated with the corresponding structural part and damage.

Step 112 is followed by step 114 in which a transmission of the measured values and/or of the analysis results derived from them as well as of the operator inputs from computer 46 to a central damage databank 66, shown schematically in FIG. 1, takes place. Central damage databank 66 is located at any desired location, as a rule at a distance from combine 10. It is preferably operated by the manufacturer of combine 10. The transmission of measured values can take place in a wireless manner by way of a data connection through the telephone network or the Internet in the form of an email or the like. It is also conceivable that the cited information at first remains saved in computer 46 and is transmitted to the central damage databank when combine 10 is located in a workshop or is being serviced by personnel authorized by the manufacturer. If computer 46 is replaceable or must be replaced due to a fault, the locally saved data that have not yet been transmitted to central damage databank 66 is transmitted to new computer 46. The new information is stored in the central damage databank. Thereby, a transformation of the operator inputs can take place into a form that can be subsequently processed by computer 46. This transformation can take place by machine and/or by a coworker.

In step 116 the second databank of combine 10 is updated based on damage databank 66, which was updated in the interim. The transmission takes place analogously to the transmission in step 114, that is, in a wireless manner by way of a data connection via the telephone network or in the form of an email or by downloading data from the Internet or by on site service or in a workshop by authorized personnel. The method than returns to step 102 then reoccurs. However, and in distinction to what has been presented, the updating of the second databank can also take place immediately after step 112 so that the new data can be immediately taken into consideration in a subsequent surveillance.

Situations are possible in step 106 in which the measured values can be associated with different faults. Therefore, information is preferably filed in the second databank about how often the faults under consideration occurred in the past. The most frequently occurring fault is preferably displayed first to the operator. Alternatively, possible faults with their probability of being expected, derived from the frequency of their occurrence is displayed to the operator.

Some faults occur relatively infrequently so that their inclusion in the central damage databank and in the second databank would constitute an inappropriate expense in view of their low probability. There is therefore possible for an intermediate storage of these fault courses in or apart from central damage databank 66 until their occurrence number exceeds a certain threshold value. Only thereafter are these fault courses transmitted to central damage databank 66 and then from it into the second databank of the work machines.

When the first machines of a new series are delivered, for which only fault experiences from first trials are present, the second databank initially contains only these first reference data. The reference data are subsequently assembled by the method of the present invention.

It remains to be noted that it can be sufficient if the second databank contains only the reference data given by the first databank, which can reduce the memory requirement. The first databank is contained in the second databank in this embodiment. If the work machine is modified, only the second databank with the reference data that has now become relevant (that is, the reference data corresponding to the new state of the machine) must be updated.

The advantages of the procedure, in accordance with the present invention, are particularly noticeable when several work machines, such as combine 10 are being surveilled. Each fault that occurs and is eliminated on one of the work machines, can be indicated a short time later to all other surveilled work machines, before significant damage occurs that would be expensive to eliminate.

Having described the preferred embodiment, it will become apparent that various modifications can be made without departing from the scope of the invention as defined in the accompanying claims.

### ASSIGNMENT

The entire right, title and interest in and to this application and all subject matter disclosed and/or claimed therein, including any and all divisions, continuations, reissues, etc., thereof are, effective as of the date of execution of this application, assigned, transferred, sold and set over by the applicant(s) named herein to Deere & Company, a Delaware corporation having offices at Moline, Ill. 61265, U.S.A., together with all rights to file, and to claim priorities in connection with, corresponding patent applications in any and all foreign countries in the name of Deere & Company or otherwise.

What is claimed is:

1. A method for surveilling the state of work machines, comprising the steps of:
providing a plurality of work machines including a first work machine;
positioning a plurality of sensors in each of said plurality of work machines for detecting operating states of each of said work machines, including the detection of at least one of noises and vibrations produced by movable elements of each said work machine;
providing a first work machine specific databank with construction data for each of said plurality of work machines;
associating a second work machine specific databank having evaluation specific reference data with each of said work machines;
detecting measured values from at least one of said plurality of sensors in said first work machine;
analyzing said measured values regarding possible faults of said first work machine using said first databank and said second databank;
depending on said analyzing step if said measured values indicate a fault in said first work machine then executing the step of outputting of information to an operator regarding the presence of a possible fault and a determined fault location;
providing an input device to receive inputs of the operator regarding any fault of said first work machine that is found by the operator;
transmitting data containing at least one of said measured values, analyzed results derived from said measured results and operator inputs to a central damage databank, and updating of said central damage databank using said data; and
updating of said second databank based on data in said central damage databank.

2. The method of claim 1, further comprising the steps of:
inputting information regarding carrying out of a repair of said first work machine in one of said first databank and said second databank; and
analyzing measured values of said sensors.

3. The method of claim 1, further comprising the step of updating said first work machine specific databank after carrying out of at least one of a repair and a modification of said first work machine.

4. The method of claim 1, wherein said transmitting step takes place intermittently.

5. The method of claim 4, wherein in said transmitting step takes place upon a servicing of said first work machine in a workshop.

6. The method of claim 1, wherein said second databank contains information about the frequency with which a fault type was found in the past, and upon the occurrence of a fault for which similar measured values with different causes are present, the fault type that has the greater frequency is indicated to the operator.

7. The method of claim 1, wherein a fault course is only input into said central damage databank if the fault course occurrence number exceeds a threshold value.

8. A surveillance system for surveilling the state of work machines, arranged to be carried out by a surveillance method of:
providing a plurality of work machines including a first work machine;
positioning a plurality of sensors in each of said plurality of work machines for detecting operating states of each of said work machines, including the detection of at least one of noises and vibrations produced by movable elements of each said work machine;
providing a first work machine specific databank with construction data for each of said plurality of work machines;
associating a second work machine specific databank having evaluation specific reference data with each of said work machines;
detecting measured values from at least one of said plurality of sensors in said first work machine;
analyzing said measured values regarding possible faults of said first work machine using said first databank and said second databank;
depending on said analyzing step if said measured values indicate a fault in said first work machine then executing the step of outputting of information to an operator regarding the presence of a possible fault and a determined fault location;
providing an input device to receive inputs of the operator regarding any fault of said first work machine that is found by the operator;
transmitting data containing at least one of said measured values, analyzed results derived from said measured results and operator inputs to a central damage databank, and updating of said central damage databank using said data; and
updating of said second databank based on data in said central damage databank.

9. An agricultural work machine system, comprising:
a frame;
a plurality of devices coupled to said frame, said plurality of devices including movable elements;
a plurality of sensors associated with said plurality of devices for detecting operating states of the agricultural work machine, including the detection of at least one of noises and vibrations produced by said movable elements;
an input device to receive inputs of an operator regarding any fault of the agricultural work machine that is found by the operator;
a data storage computing device containing a first work machine specific databank with construction data for the agricultural work machine and a second work machine specific databank having evaluation specific reference data, said data storage computing device executing the steps of:
detecting measured values from at least one of said plurality of sensors;
analyzing said measured values regarding possible faults of the agricultural work machine using said first databank and said second databank;
depending on said analyzing step if said measured values indicate a fault in the agricultural work machine then executing the step of outputting of information to the operator regarding the presence of a possible fault and a determined fault location;
transmitting data containing at least one of said measured values, analyzed results derived from said measured results and operator inputs to a central damage databank, and updating of said central damage databank using said data; and
updating of said second databank based on data in said central damage databank.

10. The agricultural work machine system of claim 9, wherein the agricultural work machine is a harvesting machine.
